(19) United States
(12) Patent Application Publication
(10) Pub. No.: US 2006/0044551 A1
(43) Pub. Date: Mar. 2, 2006

(54) Portable security assessment device

(76) Inventors: Jianli Ren, Aliso Viejo, CA (US); Paul E. Robbins, Mission Viejo, CA (US)

Correspondence Address: Brian F. Drazich;COUDERT BROTHERS LLP, Twenty-Third Floor, 333 South Hope Street, Los Angeles, CA, 90071, US

(21) Appl. No.: 10/928,392

(22) Filed: Aug. 27, 2004

(51) Int. Cl. G01N 21/00

(52) U.S. Cl. 356/237.1

(57) ABSTRACT

A readily portable handheld security assessment device that may be manipulated for viewing the underside of objects having low ground clearance, including a high intensity light source coupled with an optical conduit adapted for uniformly illuminating the field to be viewed. A flexible ball joint assembly allows a reflector or mirror to be easily and controllably positioned and oriented under the object to facilitate visual inspection thereof while permitting the user to remain erect.

### TECHNICAL FIELD

The present invention is directed to a portable device that may be used for viewing the underside of objects having low ground clearance such as vehicles, containers and fixed or mobile equipment, to facilitate inspection thereof. The present invention may also be used to view the interior of hollow vessels, having an accessible opening, such as tanks or vaults without introducing a source of ignition.

### BACKGROUND ART

In the field of security, and more particularly in regard to inspection of vehicles and objects having low ground clearance, especially the undersides of vehicles, it is well known to raise the vehicle up off the ground through use of a ramp, or hydraulic lift, or the like, as well as to maneuver the vehicle astraddle a well or pit in which an inspector is stationed. Also, inspection with the inspector kneeling or crawling underneath the vehicle or object and inspecting the underside thereof through use of a conventional flash light is known.

In regard to inspection of hollow vessels or enclosed spaces, it is known to introduce a source of illumination such as a conventional hand-held flash light into the space to be inspected. In such instances, some or all of the inspector's person may enter into the space as well. Conducting an inspection in such a manner may expose the inspector to the atmosphere within the vessel or enclosed space that may contain toxic or inflammable compounds, and may introduce a potential source of ignition into that atmosphere.

Heretofore it is believed to be unknown to use a readily portable handheld inspection device in which a flexible ball joint assembly allows a reflector or mirror to be easily and controllably manipulated underneath a vehicle, or other object having low ground clearance, or within a hollow vessel or enclosed space, to provide the operator a view of the underside of the vehicle or object, or the interior of a hollow vessel or enclosed space, as the device is manipulated to visually scan the underside of the vehicle or object, or the interior of a vessel. In one embodiment, polymeric fiber optic conduit is positioned adjacent the perimeter of the reflector and is illuminated along its entire length, to direct light evenly toward the viewed area to illuminate the underside of a vehicle or other object, or interior of an enclosed space.

### DISCLOSURE OF INVENTION

In accordance with the principles of the present invention, a portable handheld inspection device is provided in which a flexible ball joint assembly coupled with a substantially flat planar reflector or mirror is adapted for inspection of areas that are inconvenient and/or difficult to visually inspect, such as, for example, the underside of objects having low ground clearance and the underside of vehicles. The manually manipulable reflector facilitates visually scanning the underside of such objects and vehicles. Where ambient light levels—from natural or artificial sources—alone are adequate to permit inspection, an embodiment of the present invention having no incorporated source of illumination may be utilized. However, it is known that ambient light levels underneath a vehicle or other object having low ground clearance often do not permit a thorough visual inspection of the underside of such objects and vehicles, or the interior of enclosed spaces. In such conditions, an embodiment of the present invention incorporating a light source and fiber optic conduit is preferred to permit a thorough visual inspection of such difficult and/or inconvenient to inspect areas. In this embodiment, the shaft of the handle for manipulating the device and to which the mirror or reflector is movably attached also includes a high intensity light source such as a SureFire® Model 8NX flashlight that is coupled to an optical adapter for focusing the light into the end of a fiber optic conduit mated to the optical adapter. The optical conduit extends along the interior of the hollow shaft of the handle and exits the shaft near its attachment with the flexible ball joint assembly. The optical conduit extends from the shaft and is mounted around the perimeter of the reflector. When the conduit's light source is energized, light is transmitted along the length of the fiber optic conduit, and is radiated upwardly, with respect to the surface of the reflector, from around the perimeter of the mirror or reflector to provide a steady source of uniform illumination for the inspection area.

The preferred fiber optic conduit is made of a flexible organic polymer such as, for example, LEF300 or LEF310 type optical conduit available from Lumenyte International Corporation. In operation, the conduit receives light from the light source, transmits the light along its length to the inspection area, and then radiates the light upwardly or normal to the plane of the reflector, preferably over an arc of about a 30° to either side of the normal, or in other words, over a radial arc of about 60° with respect to the linear axis of the conduit. At the distal end remote from the light source, the conduit includes an end cap in which a mirror is positioned to reflect light back into the conduit. In this manner, only the portion of the invention having the mirror and distal portion of the conduit need enter the inspection area, but the light source itself need not.

The preferred conduit is generally cylindrical in shape and includes a core, a cladding surrounding the core, a reflective layer that extends approximately 300 degrees around the circumference of the clad core and a transparent or translucent finish jacket that surrounds and encloses the reflective layer, cladding and core. Preferably, prior to application of the reflective layer and finish jacket, slits are cut in the clad core of the conduit at various predetermined distances along its length, in the inspection region, to increase the light emission radially outward during use.

In each embodiment of the present invention, manipulation and positioning of the inspection mirror is facilitated by the flexible ball joint coupling the handle shaft and the inspection mirror mounting plate. The flexible ball joint permits the inspection mirror mounting plate to be continuously adjusted over a range or arc of more than about 90° with respect to the long axis of the handle shaft. That is, the inspection mirror mounting plate may be adjusted to define any angle between about perpendicular to the handle axis and about parallel to the handle axis. The exterior surface of the flexible ball joint or knuckle is preferably fabricated of a polymeric material having a relatively low coefficient of sliding friction, such as, for example, a variety of nylon formulations, to facilitate positioning the inspection mirror under the object or vehicle to be inspected when the knuckle is placed in contact with the ground. Additionally, the knuckle is shaped to allow the inspection mirror to be easily pitched and rolled to facilitate inspection when the knuckle is rested on the ground or other surface.

Various of the components of the system are also provided with shock, adverse environment and mishandling resistance features, to render the system highly durable for use in a wide variety of conditions of use. Also, the system is portable, with the components adapted to be assembled and disassembled in relative ease, speed and simplicity.

### BRIEF DESCRIPTION OF THE DRAWINGS

Detailed drawings of the present invention are shown in the attached Figures, in which:

FIG. 1 is a perspective view of a partially disassembled illuminating embodiment of the present invention.

FIG. 2 is a top view of the illuminating embodiment of the present invention.

FIG. 3 is a detail view showing the lens assembly, flexible fitting and shaft partially disassembled.

FIG. 4 is a top view of the shaft.

FIG. 5 is a perspective view of a partially disassembled flexible joint and mirror plate.

FIG. 6A is a top view of the mirror plate and flexible joint.

FIG. 6B is a bottom view of the mirror plate and flexible joint.

FIG. 7 is a top perspective view of the mirror and optical conduit mounted on the mirror plate.

FIG. 8 is a cross-section view of the optical conduit in a region having no reflective layer.

FIG. 9 is a cross-section view of the optical conduit in a region having the reflective layer.

FIG. 10 is a perspective view of the flexible joint coupling the shaft with the mirror plate on which the mirror and optical conduit are mounted.

FIG. 11 is a front perspective view of the ball unit of the flexible joint.

FIG. 12 is a rear perspective view of the ball unit of the flexible joint.

FIG. 13 is a rear view of the ball unit of the flexible joint.

FIG. 14 is a cross-section view of the ball unit of the flexible joint.

FIG. 15 is front view of the ball unit of the flexible joint.

FIG. 16 is a bottom perspective view of the plate unit of the flexible joint.

FIG. 17 is an end view of the plate unit of the flexible joint.

FIG. 18 is a bottom view of the plate unit of the flexible joint.

FIG. 19 is a top view of the mirror plate.

FIG. 20 is a perspective view of a partially disassembled handle assembly.

FIG. 21 is a perspective view of a partially disassembled non-illuminating embodiment of the present invention.

### BEST MODE FOR CARRYING OUT THE INVENTION

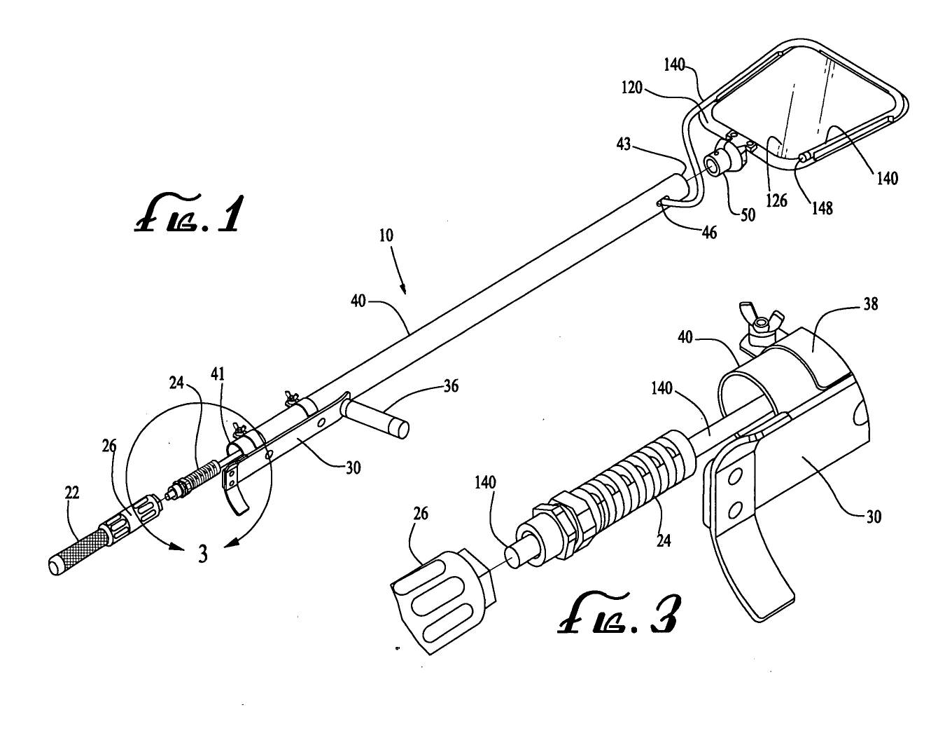

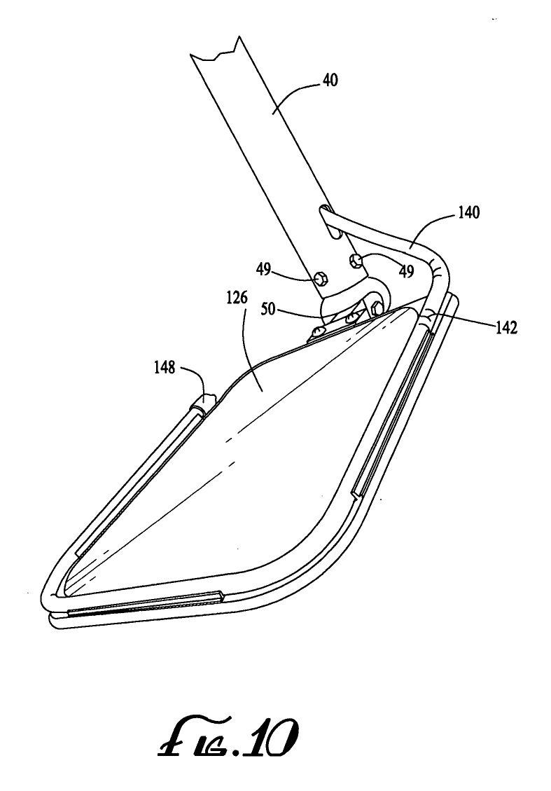

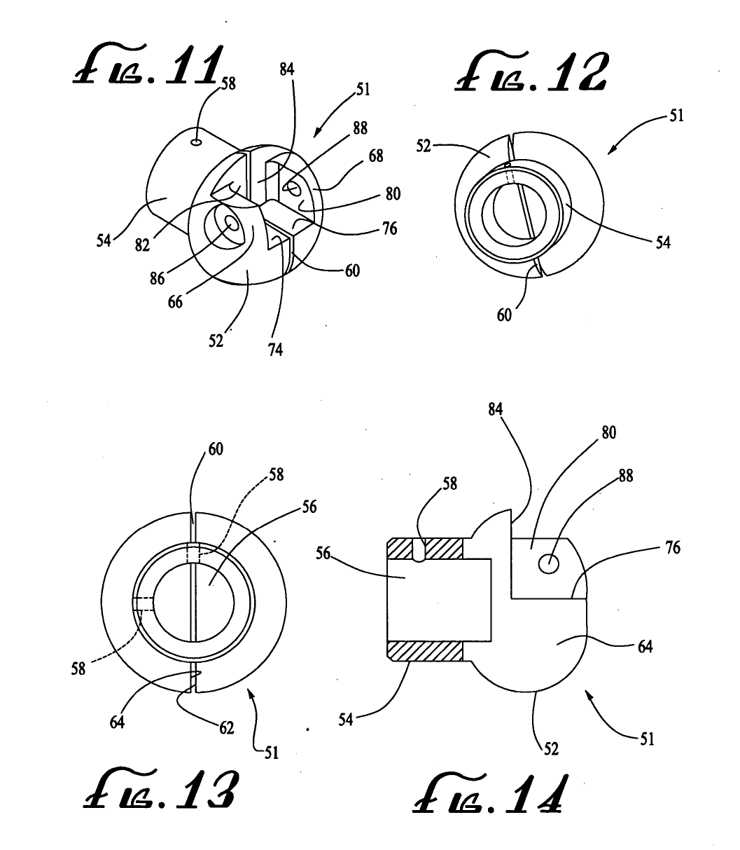

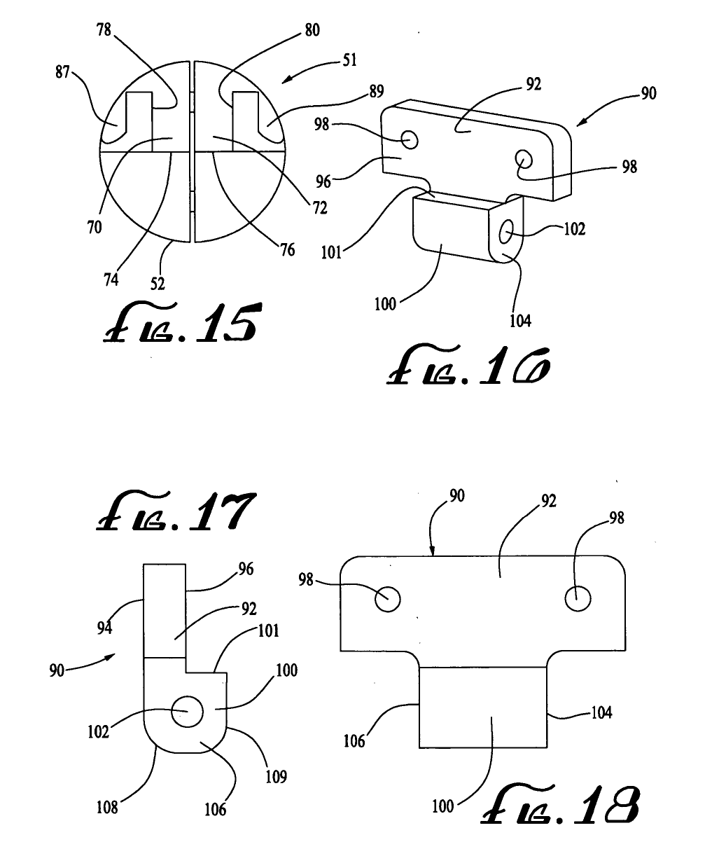

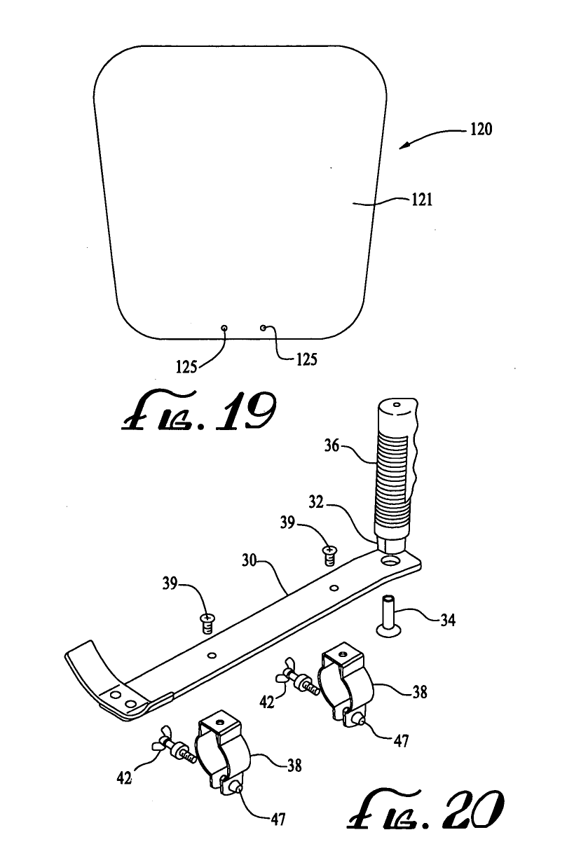

With reference to FIGS. 1-21, preferred embodiments of the present invention will be described.

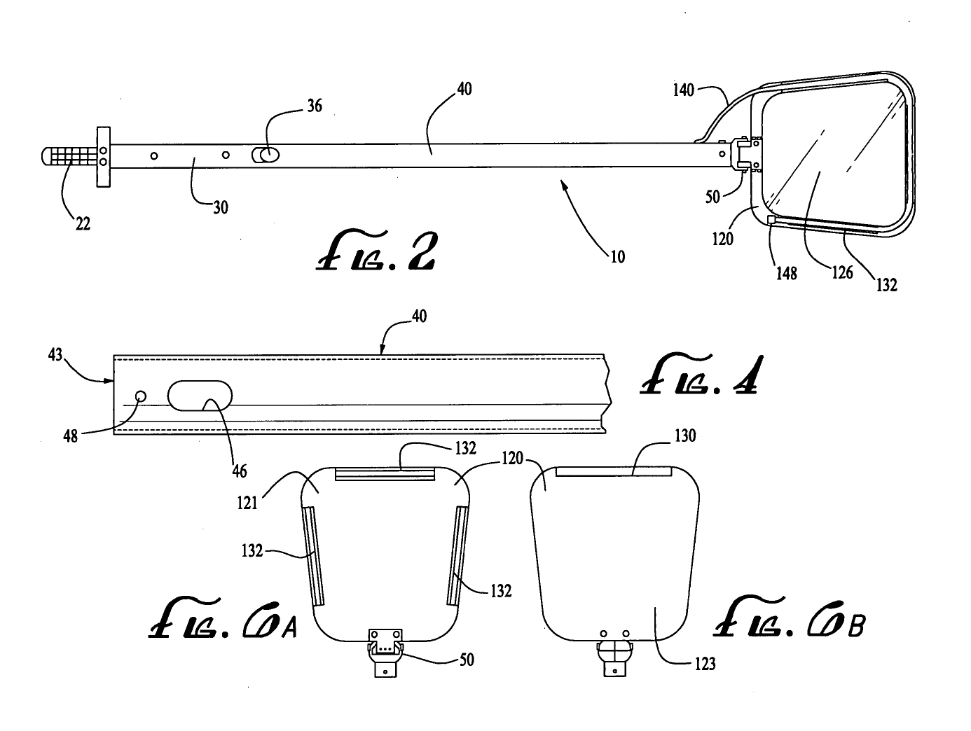

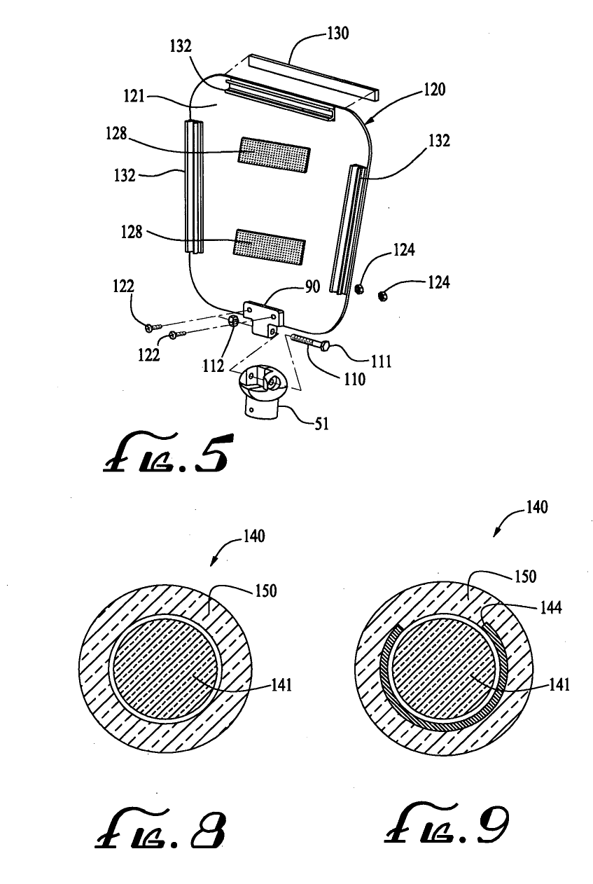

As shown in FIGS. 1-4 and 10, a preferred embodiment 10 of the portable security assessment device includes a hollow tubular shaft 40 having a lens assembly 26 removably mounted in its bore at a proximate end 41 and a reflector or mirror 126 mounted at its opposite distal end 43 by means of a flexible coupling or ball joint 50 and mirror plate 120. Lens assembly 26 is removably mounted in the bore of shaft 40 by means of set screws 29, 29 (not shown) installed through lens assembly mounting holes 28, 28 (not shown) formed in shaft 40. Shaft 40 may be fabricated of any material having suitable strength and rigidity, such as metal, plastic or composite material, but preferably is made of 6061 aluminum tubing or material having equivalent functional strength and rigidity. A polymeric optical conduit 140 is optically coupled to a light source 22 via the lens assembly 26 to which light source 22 and optical conduit 140 are each removably connected. The light source 22 and lens assembly 26 are adapted to be removably connected by any conventional means such as, for example, threads, bayonet twist catch, snap latch or friction fit. The preferred optical conduit 140 is LEF300 or LEF310 type polymeric optical conduit available from Lumenyte International Corporation, and the preferred light source 22 is a high power flashlight such as the SureFire® Model 8NX flashlight available from SureFire, LLC. With reference to FIG. 3, the optical conduit 140 is connected by means of a flexible, preferably polymeric, fitting 24 to the lens assembly 26 that focuses the light into the end of the optical conduit. The flexible fitting 24 is removably joined to the lens assembly 26 by conventional means such as, for example, threads or snap fit. The optical conduit 140 is removably joined to the flexible fitting 24 by suitable conventional means, with friction fit being preferred. Now referring to FIGS. 1-4 and 10, the optical conduit 140 extends from the lens assembly 26 along the interior or bore of shaft 40 to exit the bore through an elongated hole 46 in the shaft 40 near its distal end 43. The optical conduit 140 hence extends to the flat mirror plate 120 where the distal portion of the conduit 140 is removably affixed to an upper or first surface 121 of plate 120 by means of conduit track 132. Conduit track 132 is preferably mounted on surface 121 adjacent a predetermined portion of the perimeter of plate 120, as shown in FIGS. 5 and 6A.

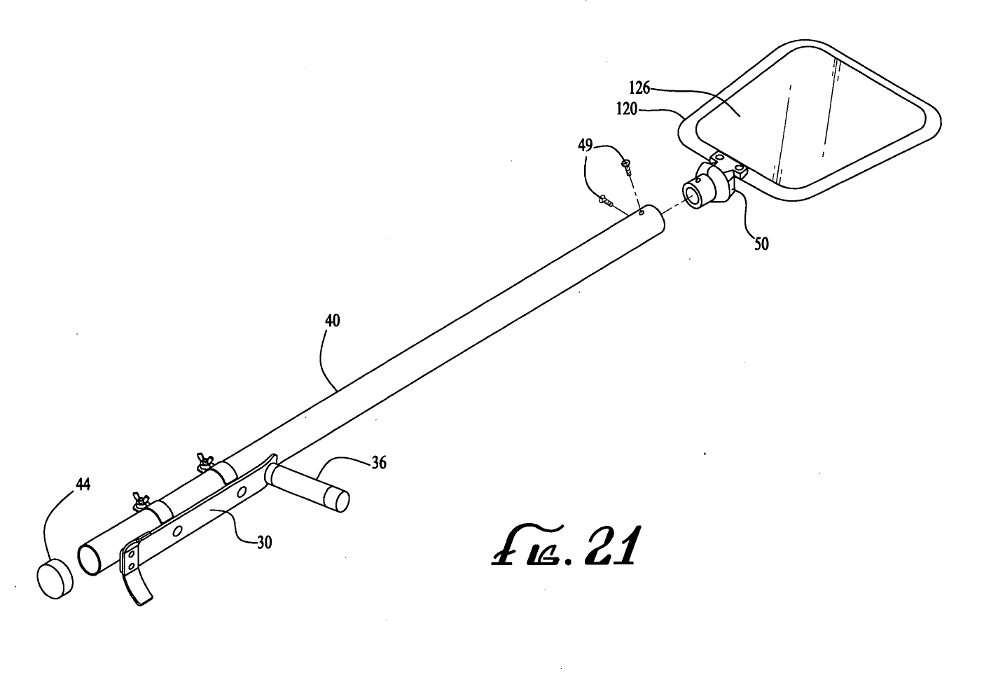

As shown in FIGS. 1, 2, 5, 7 and 10 a flat planar reflecting surface or mirror 126 is removably affixed on surface 121 of plate 120 by attachment means 128 such as, for example, double sided adhesive tape, hook and loop fasteners (like Velcro®) or suitable non-hardening adhesive. The essentially flat planar mirror 126 is thus easily replaceable and may be made of any suitable material, but is preferably made of a resilient plastic or polymeric material having one or more reflecting coatings or layers. The mirror plate 120, shown in FIGS. 5 and 19, may be fabricated of any material having suitable strength and rigidity, such as metal, plastic or composite material, but preferably is made of 5052 or 6061 sheet aluminum or material having equivalent functional strength and rigidity.

With reference to FIGS. 1, 2, 7 and 10, the mirror 126 and plate 120 are preferably of similar geometric shape, with the mirror 126 being sized to fit within the area defined by conduit track 132 such that in operation the perimeter of mirror 126 is bordered by the optical conduit 140 retained in track 132. It has been found that a preferred shape of mirror 126, and thus of plate 120, is that of a trapezoid having its narrower end proximate the connection of plate 120 to flexible joint 50. A bumper or skid 130 is mounted on the lower or second surface 123 of plate 120, preferably nearer its wider end than its narrower end, as shown in FIG. 6B. Skid 130, preferably made of a tough polymeric material, facilitates maneuvering and orientating the inspection mirror 126 under a vehicle or object to be inspected when placed in contact with the ground.

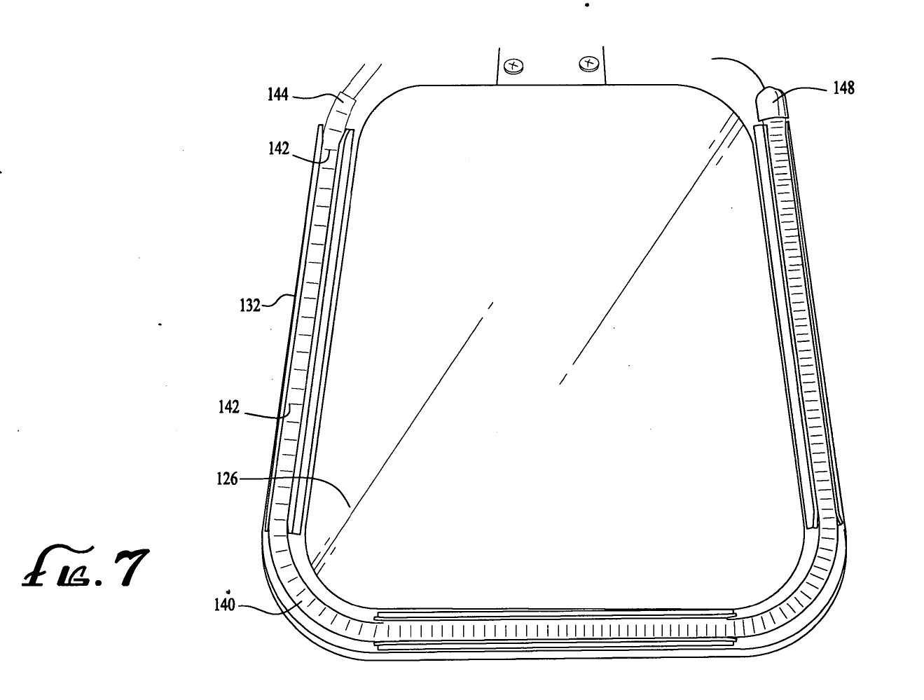

With reference to FIGS. 7-10, the fiber optic conduit or polymeric optical conduit 140 includes a clad core 141, consisting of a light transmitting polymeric core tightly surrounded by cladding as is known. In that portion of the conduit 140 disposed on mirror plate 120 and retained by track 132, a reflective layer 144 partially surrounds the periphery of the clad core 141 in a circumferential arc of approximately 300 degrees, so that light may be emitted in a circumferential arc of about 60 degrees. The entire clad core 141, including that portion to which the reflective layer 144 is applied is encased in a translucent or transparent protective polymeric finish jacket 150. The reflective layer 144 is preferably a flexible white reflective material. As shown in FIGS. 1, 2, 7 and 10, the end of the conduit 140 farthest from the light source 22, in other words the distal end of the conduit, is adapted to contact a planar mirror or conduit end mirror 146 (not shown) that reflects light reaching the distal end of the conduit back into and along the conduit. The end mirror 146 (not shown) is held in place by an end cap 148 that is encased within the conduit jacket 150. Preferably, the conduit 140 is retained in track 132 in an orientation such that, in use, light is emitted from the conduit in a circumferential arc extending to about 30 degrees away from a line drawn perpendicular or normal to the plane of mirror plate 120.

It is known that cuts or slits made in the clad core facilitate transmission of light out of an optical conduit at the location of the cut or slit. As a natural consequence of the emission of light radially outward at such a cut or slit, less light is transmitted along the conduit beyond the cut or slit. It will therefore be recognized that the size, depth, orientation and location of such cuts, as well as the spacing between the cuts, can be varied along a length of optical conduit to achieve a predetermined light distribution such as to increase and more uniformly distribute the intensity of the light emitted. To facilitate increased and more uniform illumination a preferred embodiment of the present invention, shown in FIGS. 7 and 10, includes an optical conduit 140 having a series of cuts 142 made in the clad core. The cuts 142 are made at predetermined decreasing intervals proceeding distally, or away from the light source 22, along that portion or length of the conduit 140 disposed on mirror plate 120 and retained by track 132.

Typically, in a preferred embodiment, shaft 40 typically has a length of about 42 inches and a diameter of about 1⅝ inches. Similarly, the length of conduit disposed on mirror plate 120 and retained by track 132 is about 29 inches and the overall length of the conduit is about 73 inches. Naturally, the overall length of the conduit 140 as well as the length of conduit disposed on plate 120 may change if the length of shaft 40 and/or the size of the mirror plate 120 are changed. Plate 120 typically has a length of about 11½ inches, a narrow end width of about 9¾ inches, excepting any rounding at the corners, a wide end width of about 1 13/4 inches, excepting any rounding at the corners, and a thickness of about 5/100 to 10/100 inches if made of sheet aluminum.

It will be understood by one of skill in the art that the total length and diameter of the fiber optic conduit 140, as well as the proportion of the length and circumference of clad core 141 covered by a reflective layer, together with the number, location, depth and orientation of the cuts 142 in the clad core 141, and the specifications of the light source 22, shaft 40, plate 120, mirror 126 and other components, may be varied in accordance with known principles and be within the spirit and principles of the present invention.

With respect to FIGS. 11-18, the flexible joint 50 connecting shaft 40 with mirror plate 120 of the present invention will be described. A feature of the flexible joint 50 is that it permits the mirror plate 120 to be easily positioned and maintained at any angle between from about 85 degrees to about 180 degrees with respect to the long axis of shaft 40. The flexible joint 50 preferably is made of a tough polymeric material having a relatively low coefficient of sliding friction such as nylon, of which Nylon 6,6 is preferred. The flexible coupling or joint 50 includes two subassemblies, a joint ball unit 51 and a joint plate unit 90. With reference to FIGS. 10-15, ball unit 51 has a portion defined by a generally convex outer surface 52, with an oblate spheroid shape being preferred, that is joined with a cylindrical collar portion 54. Typically the oblate spheroid shaped portion of ball unit 51 has a greatest diameter of about 2¼ inches while the collar 54 has an outside diameter of about 1½ inches and extends outward from ball surface 52 about 1 inch. Collar 54 has a central collar bore 56 that has a depth of about 1¼ inch and an inside diameter of about 1 inch typically.

With continuing reference to FIGS. 10-15, collar 54 of ball unit 51 fits snugly within the distal end 43 of shaft 40 which is slipped over collar 54 until it contacts ball unit surface 52. The shaft 40 is retained on ball unit 51 by mounting screws 49, 49 installed in screw holes 58, 58 in collar 54 through mounting holes 48, 48 in shaft 40 that are aligned with screw holes 58, 58. Preferably the cylindrical collar 54 is co-axial with the axis of rotational symmetry of the oblate spheroid portion of ball unit 51. A plane containing the axis of rotational symmetry of the oblate spheroid portion of ball unit 51 defines a bisecting slot 60 extending through the oblate spheroid portion of ball unit 51 that divides it into symmetrical halves to define first ball jaw 66 and second ball jaw 68 having facing surfaces first slot wall 62 and second slot wall 64, respectively. Bisymmetric cavities first cavity 70 and second cavity 72 are formed in first jaw 66 and second jaw 68, respectively. A plane containing the axis of rotational symmetry of the oblate spheroid of ball unit 51 defines floors 74 and 76 of cavities 70 and 72, respectively. First cavity 70 of ball unit 51 is defined by first cavity floor 74, first cavity side wall 78 and first cavity back wall 82. Second cavity 72 of ball unit 51 is a mirror image of first cavity 70, and is defined by second cavity floor 76, second cavity side wall 80 and second cavity back wall 84. First axle hole 86 penetrates first ball jaw 66 from first side wall 78 to outer convex surface 52 and is concentric with second axle hole 88 that penetrates second ball jaw 68 from second side wall 80 to outer convex surface 52. Recesses 87 and 89 are formed where the axle holes 86 and 88, respectively, penetrate convex surface 52.

Now with reference to FIGS. 16-18, flexible joint plate unit 90 is preferably formed of the same material as ball unit 51. Joint plate 90 includes a flat tab 92 and a rounded body 100. The tab 92 of plate unit 90 includes tab upper surface 94 and tab lower surface 96. Tab mounting holes 98, 98 penetrate tab 92 from upper surface 94 to lower surface 96. Tab mounting holes 98, 98 align with mirror plate mounting holes 125, 125, through which mirror plate mounting screws 122, 122 are installed and retained by mirror plate mounting nuts 124, 124 to affix mirror plate 120 to joint plate 90 with the upper surface 121 of plate 120 in contact with the lower surface 96 of tab 92. The body 100 of joint plate 90 includes wall 101 that extends outwardly from lower surface 123 where body 100 joins with tab 92. The outer surface 108 of body 100 includes lower face 109 and extends from wall 101 to upper surface 94 of joint plate 90. Outer surface 108 includes a curved or cylindrical portion preferably having the shape of half a circular cylinder. Preferably, the tab 92 of joint plate 90 has long dimension or length of about 2¼ inches and a thickness of about 5/16 inch, whereas the body 100 has a length of about 1 inch and a thickness of about ⅝ inch. Body 100 includes a central or axle bore 102 that preferably is co-axial with the axis of the center of curvature of the curved exterior surface of body 100. Axle bore 102 typically has a diameter of about ¼ inch and is adapted to sliding accept axle bolt 110. Body 100 of joint plate 90 includes first end surface 104 and second end surface 106. First end surface 104 and second end surface 106 of plate 90 are essentially flat and adapted to slide between first ball cavity side wall 78 and second ball cavity side wall 80, respectively. When so positioned, axle bore 102 and axle holes 86, 88 are aligned. With reference to FIGS. 5 and 10-18, flexible joint plate unit 90 is rotatably and removably connected with joint ball unit 51 by axle bolt 110 installed through hole 86, bore 102 and hole 88, such that the axle bolt head 111 is received in recess 87 or recess 88 of ball unit 51, and axle bolt lock nut 112 is installed on the threaded portion of axle bolt 110 and received in the other of recess 88 or recess 87. The position of lock nut 112 on axle bolt 110 is adjusted to maintain sliding rotational contact between first end surface 104 and first cavity side wall 78, and between second end surface 106 and second cavity side wall 80, respectively, such that in use frictional forces retain the relative orientation of the plate unit 90 to the ball unit 51 in a set orientation as desired, but permit the relative orientation to be readily changed manually. As assembled, plate 90 may be rotated between a position in which the upper surface 94 of tab 92 is proximate the ball cavity back walls 82, 84, to a position in which the lower face 109 of outer surface 108 of body 100 is proximate the ball cavity floors 74, 76. Typically, the angle between the axis of shaft 40 and the plane of mirror plate 120 may be varied over a range of arc of more than about 90 degrees.

With reference now to FIGS. 1, 2 and 20, the handle assembly of the present invention will be described. A handle frame 30, having a generally C-shaped arm support near one end, extends along shaft 40 near its proximate end 41. Handle frame 30 is preferably made of 5052 or 6061 aluminum stock, but may be fabricated of any material having suitable strength and rigidity. A grip core 32 is mounted on handle frame 30, at its end opposite the arm support, by means of grip core mounting screw 34. Hand grip 36 is installed on grip core 32, to facilitate manually grasping, lifting and manipulating the inspection device. Brackets 38, 38 for mounting the handle frame 30 to the shaft 40 are affixed to frame 30 by conventional means such as rivets 39, 39. Brackets 38, 38 are slipped over shaft 40 and clamped in position by tightening bracket screws 42, 42 on bracket screw nuts 47, 47. Preferably, the handle 30 is affixed to shaft 40 such that a plane defined by grip core 32 and handle frame 30 is orthogonal to the axis of axle bolt 110.

In operation, the hand-held portable security assessment device of the present invention is grasped with one hand at grip 36 by the user who rests his or her upper forearm or elbow in the C-shaped arm support of handle frame 30. When so grasped, the hand-held inspection device of the present invention is stable and easily controlled and manipulated. The ball unit 51, by reason of its particular exterior shape and low coefficient of sliding friction, facilitates sliding the inspection device along the ground under a vehicle or object to be inspected. Further, the exterior shape of ball unit 51 allows the user to easily pitch and roll the inspection mirror from side to side to scan the area to be inspected while the ball unit is in contact with the ground to provide additional stability to facilitate steady viewing of the underside of a vehicle or other object. When the light source is energized, a first embodiment of the present invention floods the area viewed in the inspection mirror with uniform illumination to reduce shadows and contrasts and so facilitate visual inspection.

A second embodiment of the present invention is described with reference to FIG. 21. The second embodiment is intended for use where ambient lighting is sufficient to provide illumination suitable for inspection. Of course, the first embodiment may be used in such conditions without the need to energize its light source. The second embodiment includes all the features of the first embodiment with the exception of those elements associated with providing illumination. That is, the second embodiment does not include the light source 22, flexible fitting 24, lens assembly 26, optical conduit track 132 and optical conduit 140. In place of light source 22, the second embodiment of the present invention includes a shaft end cap 44 to cover the bore of shaft 40.

While the present invention has been described in connection with what is presently considered to be the most practical and preferred embodiments, it is to be understood that the invention is not to be limited to the disclosed embodiments, but to the contrary, is intended to cover various modifications and equivalent arrangements included within the spirit of the invention, which are set forth in the appended claims, and which scope is to be accorded the broadest interpretation so as to encompass all such modifications and equivalent structures.

We claim the following:

1. A portable security assessment device comprising:
a light source optically coupled to a lens assembly that focuses light from said light source onto a first end of a light transmitting optical conduit;
the light source, lens assembly and a first portion of said optical conduit supported by a shaft having a handle for manually manipulating said shaft;
a mirror plate having a first surface defining a perimeter;
a mirror mounted on said first surface of said mirror plate;
said mirror plate flexibly coupled to said shaft;
a second portion of said optical conduit disposed on said first surface of said mirror plate adjacent at least a portion of said perimeter;
said second portion of said optical conduit configured to emit radially in a predetermined circumferential arc light transmitted from said light source; and
said circumferential arc includes a line extending outwardly orthogonally from said first surface of said mirror plate.

2. A portable security assessment device comprising:
a shaft having a first end, a second end and a handle attached nearer said first end than said second end for manually manipulating said shaft;
a light source optically coupled to a lens assembly for focusing light from said light source onto a first end of a light transmitting optical conduit;
said light source, lens assembly and a first portion of said optical conduit supported on said shaft;
a mirror plate having a first surface defining a perimeter;
a mirror mounted on said first surface of said mirror plate;
a flexible ball joint coupling said mirror plate to said second end of said shaft;
said flexible ball joint adapted for sliding along the ground and for orienting said mirror plate in relation to the ground;
a second portion of said optical conduit disposed on said first surface of the mirror plate adjacent at least a portion of said perimeter;
said second portion of said optical conduit configured to emit radially in a predetermined circumferential arc light transmitted from said light source; and
said circumferential arc is directed outwardly from said first surface of said mirror plate.

3. A hand-held portable security assessment device comprising:
a light transmitting optical conduit of predetermined length adapted to be illuminated by a light source;
said light source optically coupled to said optical conduit;
said light source and a first portion of said optical conduit mounted upon a shaft;
said shaft adapted to be held and manipulated by a human forelimb;
said optical conduit including a clad core and a reflective layer sheathed by a surrounding light transmitting polymeric jacket;
cuts having predetermined shape and depth formed in said clad core at predetermined intervals extending over a second predetermined portion of the length of said optical conduit;
said reflective layer overlaying said cuts formed in said clad core extending over said second predetermined portion of the length of said optical conduit;
said reflective layer extending over a predetermined circumferential arc of the clad core;
a mirror mounted on a mirror plate;
said mirror plate flexibly coupled to said shaft adapted to be selectively positionable relative to said shaft;
said second predetermined portion of said optical conduit positioned on said mirror plate adjacent to said mirror; and
said optical conduit is oriented so light from said light source is emitted outwardly relative to said mirror plate.

4. A portable security assessment device comprising:
a shaft having a first end, a second end and a handle attached nearer said first end than said second end for manually manipulating said shaft;
a mirror plate having a first surface;
a mirror mounted on said first surface of said mirror plate;
a flexible ball joint coupling said mirror plate to said second end of said shaft;
said flexible ball joint adapted for sliding along the ground and for orienting said mirror plate in relation to the ground.
